(19) United States
(12) Patent Application Publication
(10) Pub. No.: US 2015/0343445 A1
(43) Pub. Date: Dec. 3, 2015

(54) METHOD OF PRODUCING A REAGENT ON-BOARD AN INSTRUMENT

(71) Applicant: LEICA BIOSYSTEMS BOURNE PTY LTD, Mt. Waverley, Victoria (AU)

(72) Inventor: Stephen John BAGNATO, Mt. Waverley (AU)

(73) Assignee: LEICA BIOSYSTEMS MELBOURNE PTY LTD, Mt. Waverley, Victoria (AU)

(21) Appl. No.: 14/653,956

(22) PCT Filed: Dec. 20, 2013
(86) PCT No.: PCT/AU2013/001499

§ 371 Date: Jun. 19, 2015

Related U.S. Application Data
(60) Provisional application No. 61/745,331, filed on Dec. 21, 2012.

(51) Int. Cl. B01L 3/00

(52) U.S. Cl. CPC B01L 3/52; B01L 3/563; B01L 3/565; B01L 3/527; B01L 2200/026; B01L 2200/0605; B01L 2200/0689; B01L 2200/16; B01L 2200/143

(57) ABSTRACT

The present invention relates broadly to production of a reagent on-board an instrument. The instrument is provided with one or more mixing wells 10 for dilution of a concentrate 12 with a diluent to provide the reagent at the required concentration.

### FIELD OF THE INVENTION

The present invention relates broadly to a method of producing a reagent on-board an instrument such as a laboratory instrument for treating a biological tissue sample with the reagent. The invention also relates generally to an instrument utilising a reagent produced on-board the instrument from a mixture of a concentrate and a diluent. The invention further relates broadly to a concentrate dispenser for on-board production of an instrument reagent.

### BACKGROUND TO THE INVENTION

Immunohistochemical staining and in situ nucleic acid analysis are tools used in histological diagnosis and the study of tissue morphology. Immunohistochemical staining relies on the specific binding affinity of antibodies with epitopes in tissue samples, and the increasing availability of antibodies which bind specifically with unique epitopes present only in certain types of diseased cellular tissue. Immunohistochemical staining involves a series of treatment steps conducted on a tissue sample (typically a section) mounted on a glass slide to highlight, by selective staining, certain morphological indicators of disease states.

Typical treatment steps include pretreatment of the tissue sample to reduce non-specific binding, antibody treatment and incubation, enzyme labelled secondary antibody treatment and incubation, substrate reaction with the enzyme to produce a fluorophore or chromophore highlighting areas of the tissue sample having epitopes binding with the antibody, counterstaining, and the like. Between each treatment step, the tissue sample must be rinsed to remove unreacted residual reagent from the prior step. Most treatment steps involve a period of incubation typically conducted at ambient temperature of around 25° C. up to around 40° C., while cell conditioning steps are typically conducted at somewhat higher temperatures, e.g. 90° C. to 100° C. In-situ DNA analysis relies upon the specific binding affinity of probes (DNA binding proteins) with unique nucleotide sequences in cell or tissue samples and similarly involves a series of process steps, with a variety of reagents and process temperature requirements. Some specific reactions involve temperatures up to 120° C. to 130° C.

In these various treatment steps it is understood that no single concentration of antibody is sufficient to account for tissue variations, processing variability and tissue sample thickness. Reagents are provided in a Ready to Use (RTU) format that cannot be varied in concentration. Alternatively, concentrates are supplied and diluted to achieve a range of staining options. However, these approaches do not address increasing customer need for workflow flexibility with ease of reagent uses.

### SUMMARY OF THE INVENTION

According to a first aspect of the invention there is provided an instrument utilizing a reagent, said instrument including:
a chamber adapted to contain a concentrate;
a diluent dispenser operatively coupled to the chamber to dispense diluent for mixing with the concentrate on-board the instrument to provide the reagent at a required concentration.

Preferably the instrument includes one or more mixing wells located on the instrument and configured to receive the concentrate and the diluent for mixing to provide the reagent at the required concentration. In one embodiment the mixing well is formed in a sample staining module (SSM) of the instrument. Even more preferably the mixing well is formed in a fixed or disposable cover member of the SSM. Alternately the mixing well is a dedicated mixing well formed integral with the instrument.

Preferably the mixing wells are located adjacent one another for serial dilution of the concentrate with the diluent. Alternately the instrument includes a probe having an in-line mixing chamber adapted to receive the concentrate and the diluent to provide the reagent at the required concentration.

Preferably the chamber is a container supplied in a sealed condition and adapted to contain a predetermined volume of the concentrate. More preferably the sealed container includes a sealing membrane arranged to contain the concentrate and an inert gas. Even more preferably the sealing membrane is designed to be at least partly removed or pierced and the container is sized for addition of diluent for mixing on-board the instrument to provide the reagent at the required concentration. Alternatively or additionally the chamber comprises a plurality of the sealed containers each adapted to contain a predetermined volume of the concentrate. In this embodiment the plurality of chambers are arranged as multiple reservoirs in a blister pack. In another embodiment the chamber is a disposable or reusable probe tip containing the concentrate and adapted to fit to a dispensing probe of the instrument.

According to a second aspect of the invention there is a concentrate dispenser operatively coupled to an instrument for on-board provision of a reagent, said dispenser comprising packaging adapted to contain a plurality of concentrate capsules, the packaging configured to release each of the capsules for mixing with a diluent on-board the instrument to provide the reagent at the required concentration.

Preferably the packaging includes a stacked cartridge adapted to contain one or more columns of the plurality of concentrate capsules. In some embodiments two or more columns of the concentrate capsules are provided in the cartridge. More preferably the dispenser also comprises a reciprocating release operatively coupled to the stacked cartridge to release a lowermost of the column of capsules form the cartridge for mixing with the diluent on-board the instrument. Alternatively the packaging includes a cartridge reel adapted to contain a roll of the concentrate capsules retained in a concentrate tape configured to be dispensed from the cartridge reel. In this embodiment the concentrate tape includes two strips adhered to one another with the concentrate capsules sandwiched therebetween and adapted to be released from the concentrate tape.

According to a third aspect of the invention there is provided an instrument utilising a reagent, said instrument including:
a diluent chamber adapted to contain a diluent;
a concentrate dispenser operatively coupled to the diluent chamber to dispense concentrate for mixing with the diluent on-board the instrument to produce the reagent at a required concentration.

Preferably the concentrate is contained in dissolvable capsules designed to dissolve during mixing with the diluent to produce the reagent. In this embodiment the diluent is acidic or basic depending on the concentrate, and the dissolvable capsules are formed at least in part of a material which dissolves in the acidic or basic diluent.

Preferably the diluent chamber is a vacuum chamber to which the concentrate dispenser is operatively coupled wherein the concentrate is dispensed into the vacuum chamber with the assistance of vacuum pressure applied to the diluent chamber. Alternatively the concentrate dispenser includes a plunger for dispensing of the concentrate into the diluent chamber, preferably via a non-return valve. Still alternatively the concentrate dispenser includes a frangible separator which cooperates with the diluent chamber wherein rupturing of the frangible separator effects dispensing of the concentrate to the diluent chamber.

Generally the instrument is a laboratory instrument and the reagent is a high value reagent such as a molecular probe such as a nucleic acid probe or an antibody (Ab). The concentrate may be in any state such as a liquid, solid, or lyophilised state.

According to a fourth aspect of the invention there is provided a method of producing a reagent on-board an instrument, said method including the steps of:
providing a concentrate at the instrument;
discharging the concentrate into a diluent provided at the instrument, or vice versa;
mixing the concentrate with the diluent on-board the instrument to provide the reagent at a required concentration.

In one embodiment the method may also comprise one or more subsequent steps of diluting the reagent with additional diluent to produce the required concentration.

According to a fifth aspect of the invention there is provided packaging for use with an instrument in the on-board provision of a reagent, the packaging being adapted to contain a plurality of concentrate capsules, and configured to release each of the capsules for mixing with a diluent on-board the instrument to provide the reagent.

According to a sixth aspect of the invention there is provided a container for use with an instrument in the on-board provision of a reagent, the container adapted to contain a predetermined volume of a concentrate for mixing with a diluent on-board the instrument to provide the reagent.

According to a seventh aspect of the invention there is provided a cover member for use with an instrument in the on-board provision of a reagent, the cover member including a well being adapted to receive a concentrate for mixing with a diluent on-board the instrument to provide the reagent.

### BRIEF DESCRIPTION OF THE DRAWINGS

In order to achieve a better understanding of the nature of the present invention a preferred embodiment of an instrument utilizing a reagent will now be described, by way of example only, with reference to the accompanying drawings in which:

FIG. 1 is a schematic of packaged concentrate dispensed into a cover member associated with a sample staining module (SSM) of an instrument having on-board production of the reagent according to an embodiment of one aspect of the invention;

FIGS. 2(a) and 2(b) are schematics of alternative embodiments of mixing wells or chambers designed for on-board production of reagents;

FIGS. 3(a) and 3(b) are schematics of alternative embodiments of chambers designed to be used in conjunction with the instrument of for example FIG. 1;

FIGS. 4(a) to 4(d) are schematics of different concentrate dispensers designed for the on-board provision of a reagent at an instrument according to embodiments of another aspect of the invention;

FIGS. 5(a) to 5(c) are schematics of packaged concentrates/diluents used to produce reagents on-board an instrument according to embodiments of a further aspect of the invention.

### DETAILED DESCRIPTION

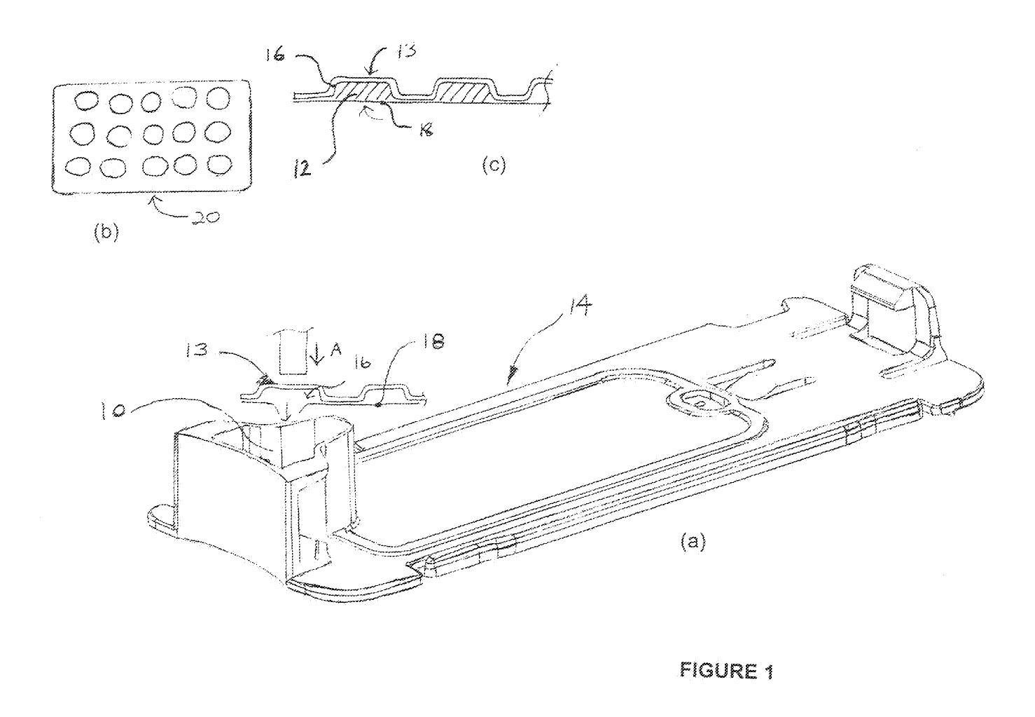

FIG. 1 is a schematic illustration of a mixing well 10 associated with an instrument (not shown) for mixing a concentrate 12 with a diluent (not shown) on-board the instrument to provide a reagent at a required concentration. The mixing well 10 is in this embodiment formed in a cover member 14 associated with a sample staining module (SSM) of the instrument. The cover member 14 may be releasably attachable to the SSM of the instrument. The mixing well in an alternative embodiment may be formed as an integral part of the instrument. The instrument of this aspect of the invention is a laboratory instrument for treating a biological tissue sample within the SSM with the reagent, typically in the form of a molecular probe such as a nucleic acid probe or an antibody (Ab). The high value reagent is produced at a desired concentration on-board the instrument by mixing the concentrate such as 12 and diluent to provide the reagent at the required concentration.

In the embodiment of FIG. 1 the concentrate 12 is provided in a sealed container 13. The sealed container 13 includes a sealing membrane 18 arranged to contain the concentrate 12 within a plurality of sealed chambers 16. The sealed container 13 of this example is in the form of a blister pack 20. The blister pack 20 is designed to release each of the concentrate volumes such as 12 into the well 10 of the cover member 14. The sealing membrane 18 which is in the form of a frangible foil is ruptured or otherwise broken or removed across an entry to the well 10 for release of the concentrate 12. The diluent may be pumped from a bulk supply into the well 10 either before or after addition of the concentrate to achieve the required concentration. The reagent is thus mixed and produced on-board the instrument. The reagent may then be drawn under the cover member 14 or aspirated using a robot and a fluid transport probe (not shown) and then dispensed through a port 9 into a reaction area 11 for treatment, such as staining.

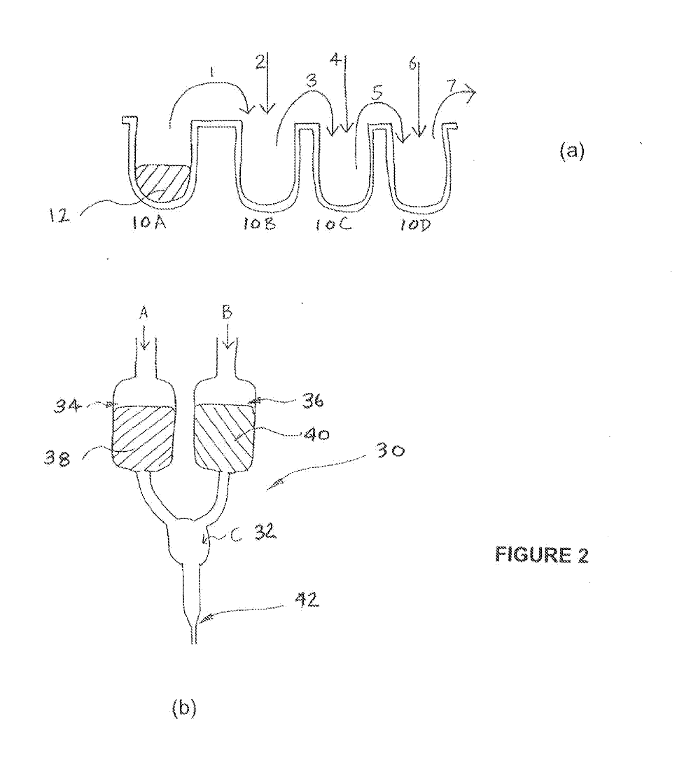

FIGS. 2(a) and 2(b) illustrate alternative embodiments suitable for production of a reagent on-board an instrument such as that including the cover member 14 of the previous embodiment of FIG. 1. For ease of reference and to avoid repetition, the same reference numerals have been used for similar components of this and any other embodiments. In the embodiment of FIG. 2(a) the instrument is provided with multiple mixing wells 10A to 10D for serial dilution of the concentrate 12. The reagent 12 is at stage 1 transferred to the mixing well 10B and at stage 2 diluted with diluent. The resulting reagent is mixed in the mixing well 10B and at stage 3 transferred to mixing well 10C for further dilution at stage 4 with diluent. The resulting reagent is mixed in mixing well 10C and at stage 5 transferred to mixing well 10D for further dilution with diluent at stage 6. The final reagent at its required concentration is at stage 7 transferred from the mixing well 10D for use by the instrument. It will be appreciated by those skilled in the art that the number of mixing wells required for each desired dilution may vary according to the required dilution. Accordingly, the number of mixing wells provided or utilized may vary according to the required dilution. The final reagent may for example be used in staining a tissue sample located on a slide (not shown) of the SSM. The multiple mixing wells 10A to 10D may be formed as an integral part of the instrument in for example the SSM or as shown in FIG. 1 fabricated in a fixed or disposable cover member of the SSM.

In the embodiment of FIG. 2(b) the instrument includes a probe 30 having an in-line mixing chamber 32. The probe is for example in the form of a fluid transfer probe (FTP) of an instrument used for treating or staining tissue samples on slides. The modified FTP 30 includes a diluent chamber 34 and a chamber 36 located up stream of the mixing chamber 32. The diluent and chambers 34/36 provide the requisite volume of diluent 38 and concentrate 40 to the mixing chamber 32 to provide a reagent at the required concentration. The FTP includes a nozzle 42 downstream of the mixing chamber 32 which is configured to dispense into a cover member of an SSM. The nozzle 42 may discharge reagent directly on to the sample slide or into a port of a cover member such as 14 (see FIG. 1) associated with the SSM. In one embodiment the instrument may incorporate a separate valve or valves (not shown) arranged on or adjacent to the mixing chamber.

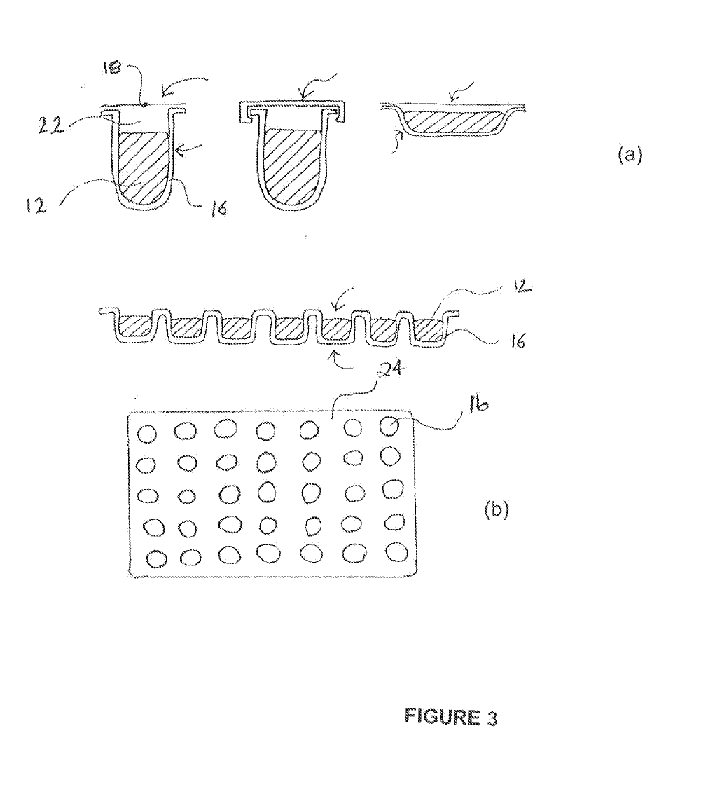

FIGS. 3(a) and 3(b) are alternate embodiments of a chamber suitable for use with an instrument providing on-board production of a reagent. The chambers may for example be suitable for use with the cover member 14 of the instrument of FIG. 1. In the various embodiments of FIG. 3(a) the concentrate such as 12 is contained in a chamber 16 which is sealed with a sealing membrane 18. The concentrate 12 is protected from evaporation and oxidation by the use of nitrogen or other inert gases 22 sealed within the chamber 16. The sealing membrane 18 may be in the form of a foil pack or lid seal. The embodiment of FIG. 3(b) is similar to the blister pack 20 of FIG. 1 having multiple chambers such as 16 in a common base plate 24. Although not shown the multiple chambers 16 may also be sealed with a common sealing membrane or foil.

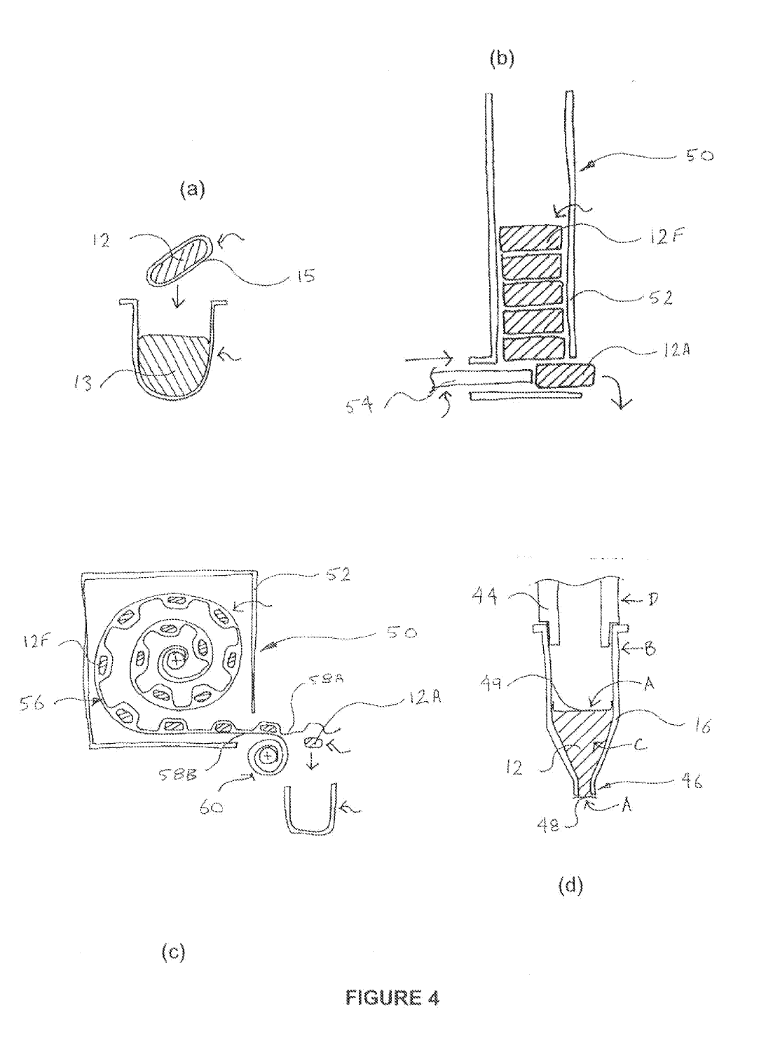

FIGS. 4(a) to 4(d) illustrate different embodiments of a concentrate dispenser for use on-board an instrument in production of a reagent, for example the reagent being used in staining or otherwise treating tissue samples in an SSM of the instrument. The embodiment of FIG. 4(a) schematically depicts mixing of a concentrate 12 with a diluent 13 to provide the reagent. The concentrate 12 is in this embodiment contained in a dissolving capsule 15 designed to dissolve during mixing with the diluent 13. The diluent 13 may be acidic or basic depending on the chemistry of the concentrate, and the capsule 15 formed of a material which dissolves in the diluent 13. The diluent 13 may be contained in a mixing well associated with a cover member 14 of the SSM.

In the embodiments of FIGS. 4(b) and 4(c), the concentrate such as 12 is contained in a concentrate dispenser 50 operatively coupled to an instrument for on-board provision of a reagent. The concentrate dispenser 50 includes packaging 52 within which one of a plurality of the concentrate capsules such as 12A to 12F are contained in a stacked cartridge. The stacked cartridge packaging 52 is designed to release each of the capsules such as 12A for mixing with a diluent on-board the instrument to provide a reagent at the required concentration. In the embodiment of FIG. 4(b) the concentrate dispenser 50 includes a reciprocating release 54 operatively coupled to the stacked cartridge 52 to release a lowermost of the column of capsules such as 12A.

In the embodiment of FIG. 4(c), the packaging of the concentrate dispenser 50 is in the form of a cartridge reel 52. The cartridge reel contains a roll of the concentrate capsules such as 12A to 12F retained in a concentrate tape 56 dispensed from the cartridge reel 52. The concentrate tape 56 includes two strips 58A and 58B adhered to one another with the concentrate capsules such as 12F sandwiched therebetween. The concentrate dispenser 50 of FIG. 4(c) also includes a spool 60 for removing the lower strip 58B of the concentrate tape 56 to release each of the concentrate capsules such as 12A from the dispenser 50.

In the embodiment of FIG. 4(d) the instrument includes a chamber 16 in the form of a disposable or reusable probe tip containing the concentrate 12. The probe tip 16 is designed to fit to a probe such as 44 of the concentrate dispenser. The probe may for example be in the form of a FTP of an instrument used in treating or staining tissue samples. In this case the probe tip 16 includes a nozzle 46 designed to cooperate with a port of for example a cover member of a SSM. The nozzle 46 includes a temporary seal 48 which is designed to rupture on discharge of the concentrate 12 into the well for mixing with the diluent. The concentrate 12 may also be sealed in the probe tip 16 with another seal 49 which is similarly ruptured under the application of pressure applied by the FTP 44.

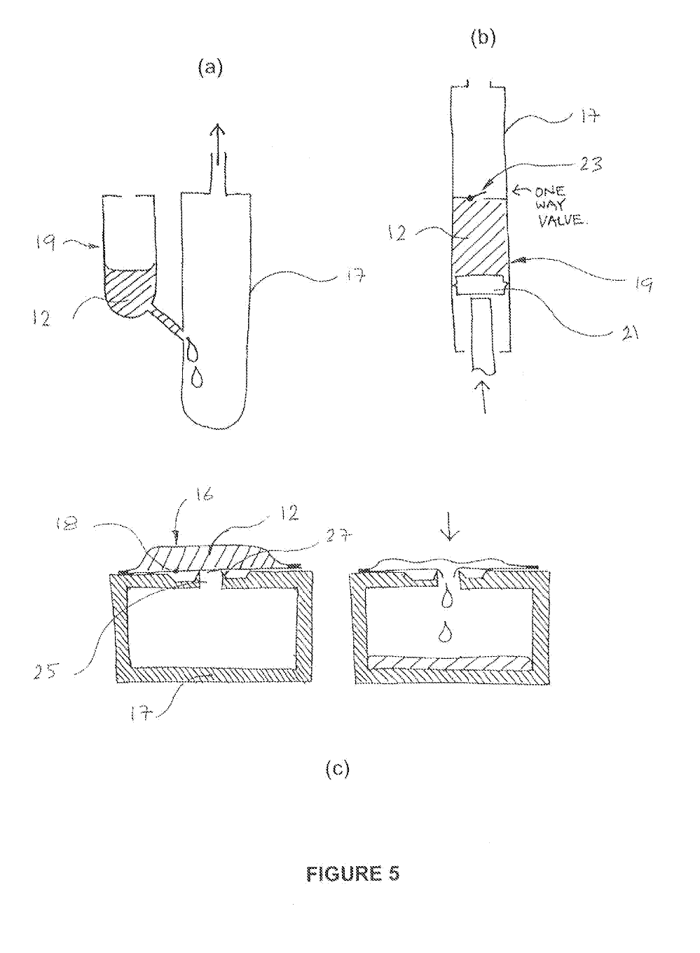

FIGS. 5(a) to 5(c) illustrate various embodiments of a diluent chamber 17 operatively coupled to a concentrate dispenser 19 for mixing on-board an instrument to produce a reagent. The diluent chamber is in the form of a mixing vial 17 with the concentrate dispenser 19 attached as a single package. In the embodiment of FIG. 5(a) the diluent vial 17 has a vacuum pressure applied to it for dispensing of the concentrate 12 from the concentrate dispenser 19. In the embodiment of FIG. 5(b) the concentrate dispenser 19 includes a plunger 21 for urging the concentrate 12 from the concentrate dispenser 19 into the diluent vial 17. The concentrate dispenser 19 may include a one way valve 23 through which the concentrate 12 is discharged into the diluent vial 17. The embodiment of FIG. 5(c) includes a concentrate dispenser in the form of the packaged chamber 16 such as the embodiments of FIG. 3(a). The chamber 16 is operatively coupled to the diluent chamber or vial 17 with its sealing membrane 18 in contact with an entrance 25 to the diluent chamber 17. The entrance 25 includes a spiked ridge 27 designed on the application of downward pressure to the chamber 16 to rupture the frangible sealing membrane 18. The concentrate 12 is thus discharged into the diluent chamber 17 for mixing to produce the necessary reagent.

It will be readily understood by those skilled in the art that a concentrate includes liquids of varying concentrations and for example includes high-value reagents and bulk reagents. The FTP of the earlier embodiment may thus extend to dispensing a reagent to be diluted, a diluent, other reagents, or a combination of these liquids.

The instrument in one embodiment may include a controller configured to implement the preferred method of producing a reagent on-board the instrument. The method may be implemented via computer program code including instructions to control movement of a concentrate dispenser in, for example, dispensing a concentrate to a well of a cover member associated with a SSM. The controller may also control dilution and mixing of the concentrate with a diluent to provide the reagent at the required concentration.

Now that several preferred embodiments of the invention have been described it will be apparent to those skilled in the art that the method of producing a reagent on-board an instrument together with the concentrate dispenser and associated packaging has at least the following advantages:
1. The concentration of the reagent produced on-board the instrument can be varied, for example, to achieve the required staining option for tissue samples;
2. The ability to produce reagents on-board an instrument increase workflow flexibility with ease of use, for example by controlling the parameters of the dilution based on the supplied concentrate errors in staining are reduced;
3. On-board dilution lends itself to reagents in a liquid, solid and lyophilised form;
4. On-board dilution improves laboratory workflow without having to pre-dilute reagents from concentrates and also reduces operator time and potential errors.

Those skilled in the art will appreciate that the invention described herein is susceptible to variations and modifications other than those specifically described. All such variations and modifications are to be considered within the scope of the present invention the nature of which is to be determined from the foregoing description.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

1-37. (canceled)

38. An instrument utilizing a reagent, said instrument including:
a chamber adapted to contain a concentrate; and
a diluent dispenser operatively coupled to the chamber to dispense diluent for mixing with the concentrate on-board the instrument to provide the reagent at a required concentration.

39. An instrument as defined in claim 38 also including one or more mixing wells located on the instrument and configured to receive the concentrate and the diluent for mixing to provide the reagent at the required concentration.

40. An instrument as defined in claim 39 wherein the mixing well includes a fixed or disposable cover member associated with the instrument.

41. An instrument as defined in claim 38 wherein the instrument includes a probe having an in-line mixing chamber adapted to receive the concentrate and the diluent to provide the reagent at the required concentration.

42. An instrument as defined in claim 41 wherein the chamber is a sealed container supplied in a sealed condition and adapted to contain a predetermined volume of the concentrate.

43. An instrument as defined in claim 42 wherein the sealed container includes a sealing membrane arranged to contain the concentrate and an inert gas.

44. An instrument as defined in claim 43 wherein the sealing membrane is designed to be at least partly removed or pierced and the sealed container is sized for addition of diluent for mixing on-board the instrument to provide the reagent at the required concentration.

45. An instrument as defined in claim 42 wherein the chamber is a disposable or reusable probe tip containing the concentrate and adapted to fit to a dispensing probe of the instrument.

46. A concentrate dispenser operatively coupled to an instrument for on-board provision of a reagent, said dispenser comprising packaging adapted to contain a plurality of concentrate capsules, the packaging configured to release each of the capsules for mixing with a diluent on-board the instrument to provide the reagent at the required concentration.

47. A concentrate dispenser as defined in claim 46 wherein the packaging includes a stacked cartridge adapted to contain one or more columns of the plurality of concentrate capsules,
wherein the dispenser also comprises a reciprocating release operatively coupled to the stacked cartridge to release a lowermost of the column of capsules form the cartridge for mixing with the diluent on-board the instrument.

48. A concentrate dispenser as defined in claim 46 wherein the packaging includes a cartridge reel adapted to contain a roll of the concentrate capsules retained in a concentrate tape configured to be dispensed from the cartridge reel.

49. A concentrate dispenser as defined in claim 48 wherein the concentrate tape includes two strips adhered to one another with the concentrate capsules sandwiched therebetween and adapted to be released from the concentrate tape.

50. A method of producing a reagent on-board an instrument, said method including the steps of:
providing a concentrate at the instrument;
discharging the concentrate into a diluent provided at the instrument, or vice versa; and
mixing the concentrate with the diluent on-board the instrument to provide the reagent at a required concentration.

51. A method as defined in claim 50 also comprising one or more subsequent steps of diluting the reagent with additional diluent to produce the required concentration.

52. Packaging for use with an instrument according to claim 38 in the on-board provision of a reagent, the packaging being adapted to contain a plurality of concentrate capsules, and configured to release each of the capsules for mixing with a diluent onboard the instrument to provide the reagent.

53. Packaging as defined in claim 52 including a stacked cartridge adapted to contain one or more columns of the plurality of concentrate capsules.

54. Packaging as defined in claim 52 including a cartridge reel adapted to contain a roll of the concentrate capsules retained in a concentrate tape configured to be dispensed from the cartridge reel.

55. A container for use with an instrument according to claim 38 in the on-board provision of a reagent, the container adapted to contain a predetermined volume of a concentrate for mixing with a diluent on-board the instrument to provide the reagent.

56. A container as defined in claim 55 wherein the container is a sealed container.

57. A container as defined in claim 56 wherein the sealed container includes a sealing membrane arranged to contain the concentrate and an inert gas.

58. A container as defined in claim 57 wherein the sealing membrane is designed to be at least partly removed or pierced and the container is sized for addition of diluent for mixing on-board the instrument to provide the reagent at the required concentration.

59. A cover member for use with an instrument according to claim 38 in the on-board provision of a reagent, the cover member including a well being adapted to receive a concentrate for mixing with a diluent on-board the instrument to provide the reagent.

60. A cover member as defined in claim 59 wherein the cover member is a fixed or disposable cover member.
